(19) United States
(12) Patent Application Publication
(10) Pub. No.: US 2023/0297035 A1
(43) Pub. Date: Sep. 21, 2023

(54) SERVO SYSTEM

(71) Applicant: OMRON Corporation, Kyoto-shi, KYOTO (JP)

(72) Inventor: Yasushi ONO, Kyoto-shi (JP)

(21) Appl. No.: 18/173,352

(22) Filed: Feb. 23, 2023

(30) Foreign Application Priority Data
Mar. 15, 2022 (JP) 2022-040085

(51) Int. Cl. G05B 9/03

(52) U.S. Cl. CPC G05B 9/03

(57) ABSTRACT

A servo system includes multiple servo drivers that are operable in cooperation with each other and are each drivable independently with highest possible control accuracy. The servo system includes a first servo driver that drives a first motor, a second servo driver connected to the first servo driver with a first signal line to drive a second motor, and a host device connected to the first and second servo drivers with a second signal line. The second servo driver switches, in response to a switch command from the host device, between a first mode in which the second servo driver drives the second motor in accordance with a first control command from the first servo driver and a second mode in which the second servo driver drives the second motor in accordance with a second control command from the host device.

### CROSS-REFERENCE TO RELATED APPLICATION

This application claims priority to Japanese Patent Application No. 2022-040085 filed on Mar. 15, 2022, the contents of which are incorporated herein by reference.

### FIELD

The present invention relates to a servo system.

### BACKGROUND

A known servo system includes multiple servo drivers that drive associated motors in cooperation with each other (refer to, for example, Patent Literatures 1 and 2).

### CITATION LIST

### Patent Literature

Patent Literature 1: Japanese Unexamined Patent Application Publication No. 2003-169497

Patent Literature 2: Japanese Unexamined Patent Application Publication No. 2001-202102

### SUMMARY

### Technical Problem

The servo system may be a gantry system including multiple servo drivers operable in cooperation with each other typically using a master-slave method. With this method, a single servo driver, or a master driver, receives a command from a programmable logic controller (PLC), and another servo driver, or a slave driver, receives a command from the master driver. To cause the motor associated with the slave driver to operate independently in such a master-slave servo system, the slave driver is to receive a command from the PLC through the master driver. This can cause a delay in the command reaching the slave driver, thus lowering the accuracy for controlling the motor.

A technique according to an aspect of the disclosure is directed to a servo system including multiple servo drivers that are operable in cooperation with each other and are each drivable independently with highest possible control accuracy.

### Solution to Problem

A technique according to an aspect of the disclosure may be a servo system described below. The servo system includes a first servo driver that drives a first motor, a second servo driver connected to the first servo driver with a first signal line to drive a second motor, and a host device connected to the first servo driver and the second servo driver with a second signal line. The second servo driver switches between a first mode and a second mode in response to a switch command from the host device. The first mode is a mode in which the second servo driver drives the second motor in accordance with a first control command from the first servo driver. The second mode is a mode in which the second servo driver drives the second motor in accordance with a second control command from the host device.

In the servo system, the host device is connected to both the first servo driver and the second servo driver with the second signal line. In the second mode resulting from switching with the switch command, the host device outputs the control command to the second servo driver without using the first servo driver. The second servo driver can thus receive the control command from the host device with less delay than receiving it through the first servo driver. The servo system can thus drive the second servo driver also independently with highest possible control accuracy.

The servo system may also have the features described below. The host device obtains, from the second servo driver, second displacement information about displacement of the second motor, and outputs the second control command to the second servo driver based on a current position of the second motor indicated by the second displacement information. The second control command from the host device is based on the current position of the second motor indicated by the second displacement information about displacement of the second motor obtained from the second servo driver. This increases the accuracy of the second control command for the second servo driver.

The servo system may also have the features described below. The host device obtains, from the first servo driver, first displacement information about displacement of the first motor, obtains, from the second servo driver, second displacement information about displacement of the second motor, and disables output of the switch command for switching from the first mode to the second mode in response to a difference between the displacement of the first motor indicated by the first displacement information and the displacement of the second motor indicated by the second displacement information being greater than or equal to a position difference threshold prestored in a storage. For a gantry system with substantially regulated relative displacement between multiple motors, for example, the first motor and the second motor with a large difference in displacement can have a heavier load. Under such a difference, the servo system disables output of the switch command for switching from the first mode to the second mode to reduce any increase in the difference and thus reduce any increase in the load on the motors.

The host device may disable output of the switch command for switching from the first mode to the second mode in response to at least one of the first servo driver or the second servo driver being in a servo-on state. When at least one of the first servo driver or the second servo driver is in a servo-on state, the servo system can receive an overload in response to the second motor being driven independently of the first motor. The servo system avoids an overload by disabling output of the switch command for switching from the first mode to the second mode when at least one of the first servo driver or the second servo driver is in the servo-on state.

The host device may enable output of the switch command for switching from the first mode to the second mode in response to at least one of the first servo driver or the second servo driver being in a servo-on state and the first motor and the second motor being stopped. When at least one of the first servo driver or the second servo driver is in the servo-on state but the first motor and the second motor are both stopped, the servo system is less likely to receive an overload in response to the second motor being driven independently of the first motor. Thus, the servo system can output the switch command for switching from the first mode to the second mode while avoiding an overload.

The second servo driver may disable driving of the second motor in accordance with the second control command from the host device in response to a difference between displacement of the second motor at reception of the switch command for switching from the first mode to the second mode and displacement of the second motor in accordance with the second control command from the host device being greater than or equal to a displacement threshold prestored in a storage. The servo system can receive an overload when largely displacing the second motor independently of the first motor. The servo system avoids an overload by regulating displacement of the second motor using the displacement threshold prestored in the storage.

The second servo driver may disable control of the second motor in accordance with the second control command from the host device in response to a command torque value specified by the second control command from the host device being greater than or equal to a torque threshold prestored in a storage. The servo system can receive an overload when driving the second motor with high torque independently of the first motor. The servo system avoids an overload by regulating the torque of the second motor using the torque threshold prestored in the storage.

The host device may output the second control command to the second servo driver to drive the second motor, and may output a third control command to the first servo driver to cause the first motor to be in a free-running state. The first motor in the free-running state can be easily driven as the second motor is driven in accordance with the control command from the host device.

### Advantageous Effects

The technique according to the above aspects of the disclosure provides the servo system including the multiple servo drivers that are operable in cooperation with each other and are each drivable independently with highest possible control accuracy.

### BRIEF DESCRIPTION OF THE DRAWINGS

FIG. 1 is a diagram of an example servo system according to an embodiment.

FIG. 2 is a schematic block diagram of a PLC, showing its functional units.

FIG. 3 is a schematic block diagram of a master servo driver, showing its functional units.

FIG. 4 is a schematic block diagram of a slave servo driver, showing its functional units.

FIG. 5 is a flowchart of an example process sequence performed by the PLC.

FIG. 6 is a flowchart of an example process sequence performed by the master servo driver.

FIG. 7 is a flowchart of an example process sequence performed by the slave servo driver.

FIG. 8 is a block diagram of an example servo system according to a modification.

### DETAILED DESCRIPTION

### Embodiments

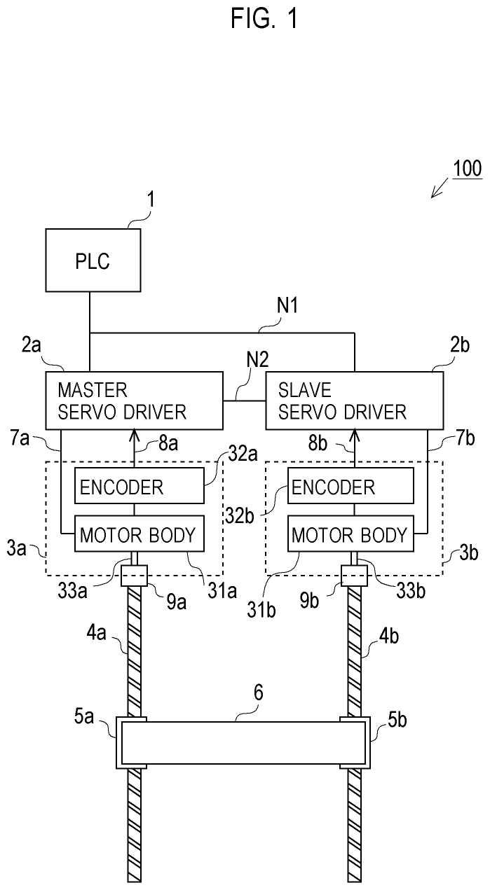

An embodiment will now be described with reference to the drawings. FIG. 1 is a diagram of an example servo system 100 according to the embodiment. The servo system 100 includes a programmable logic controller (PLC) 1, a master servo driver 2a, a slave servo driver 2b, motors 3a and 3b, threaded shafts 4a and 4b, precision stages 5a and 5b, a table 6, an industrial network N1, and an inter-driver communication line N2. The motor 3a includes a motor body 31a, an encoder 32a, and an output shaft 33a. The motor 3b includes a motor body 31b, an encoder 32b, and an output shaft 33b. The servo system 100 is, for example, a gantry system in which the master servo driver 2a and the slave servo driver 2b displace the table 6 in cooperation with each other.

The PLC 1, the master servo driver 2a, and the slave servo driver 2b are connected with the industrial network N1. The master servo driver 2a and the slave servo driver 2b are connected with the inter-driver communication line N2. The master servo driver 2a and the motor body 31a are connected with a power line 7a. The master servo driver 2a and the encoder 32a are connected with an encoder cable 8a. The slave servo driver 2b and the motor body 31b are connected with a power line 7b. The slave servo driver 2b and the encoder 32b are connected with an encoder cable 8b. The output shaft 33a and the threaded shaft 4a are connected with a coupling 9a. The output shaft 33b and the threaded shaft 4b are connected with a coupling 9b.

The master servo driver 2a and the slave servo driver 2b are also referred to as servo drivers 2 without being distinguished from each other. The motors 3a and 3b are also referred to as motors 3 without being distinguished from each other. The motor bodies 31a and 31b are also referred to as motor bodies 31 without being distinguished from each other. The encoders 32a and 32b are also referred to as encoders 32 without being distinguished from each other. The power lines 7a and 7b are also referred to as power lines 7 without being distinguished from each other. The encoder cables 8a and 8b are also referred to as encoder cables 8 without being distinguished from each other. The threaded shafts 4a and 4b are also referred to as threaded shafts 4 without being distinguished from each other. The precision stages 5a and 5b are also referred to as precision stages 5 without being distinguished from each other.

The PLC 1 outputs command signals to the servo drivers 2 through the industrial network N1. The PLC 1 performs a process in accordance with a predetermined program and serves as, for example, a device for monitoring the servo drivers 2. The industrial network N1 is, for example, a Transmission Control Protocol/Internet Protocol (TCP/IP) network. The PLC 1 is connected to both the master servo driver 2a and the slave servo driver 2b with the industrial network N1. The PLC 1 is an example of a host device.

The servo drivers 2 receive command signals from the PLC 1 through the industrial network N1. The servo drivers 2 also receive feedback signals from the encoders 32 of the corresponding motors 3 through the encoder cables 8. The servo drivers 2 supply drive currents to the motor bodies 31 of the motors 3 through the power lines 7. Each servo driver 2 includes, for example, a speed detector, a torque detector, and a power generator that define a servo system to perform feedback control. The servo driver 2 performs servo control for driving the corresponding motor 3 using signals from these components. The master servo driver 2a is associated with the motor 3a. The slave servo driver 2b is associated with the motor 3b. In other words, the master servo driver 2a performs servo control for driving the motor 3a. The slave servo driver 2b performs servo control for driving the motor 3b. The master servo driver 2a is an example of a first servo driver. The slave servo driver 2b is an example of a second servo driver.

The motors 3 are, for example, alternating current (AC) servo motors. Each motor 3 includes the motor body 31 and the encoder 32. The motor bodies 31 receive drive currents from the servo drivers 2 through the power lines 7. The encoders 32 detect motions of the motor bodies 31 driven by the servo drivers 2 and generate feedback signals indicating the detected motions. The feedback signals are output to the servo drivers 2 through the encoder cables 8. The feedback signals include, for example, information about displacement of the output shafts 33 such as information about the rotational positions (angles) of the output shafts 33 in the motor bodies 31, the rotational speeds of the output shafts 33, and the rotational directions of the output shafts 33. The encoders 32 may be, for example, any of known incremental or absolute encoders. The motor 3a is an example of a first motor. The motor 3b is an example of a second motor.

The motor 3a includes the output shaft 33a connected to the threaded shaft 4a with the coupling 9a. The threaded shaft 4a includes the precision stage 5a. The motor 3b includes the output shaft 33b connected to the threaded shaft 4b with the coupling 9b. The threaded shaft 4b includes the precision stage 5b. The precision stage 5a is displaced on the threaded shaft 4a when the motor 3a is driven. The precision stage 5b is displaced on the threaded shaft 4b when the motor 3b is driven. The precision stage 5a and the precision stage 5b support the table 6.

For operation of the master servo driver 2a and the slave servo driver 2b in corporation with each other, the master servo driver 2a drives the motor 3a in response to a command from the PLC 1 through the industrial network N1 and also outputs an inter-driver command to the slave servo driver 2b through the inter-driver communication line N2 to drive the motor 3b. Through the cooperative operation, the master servo driver 2a and the slave servo driver 2b can move the table 6 axially along the threaded shafts 4a and 4b. The mode in which the master servo driver 2a and the slave servo driver 2b operate in cooperation with each other is hereafter referred to as a cooperative mode. The cooperative mode is an example of a first mode.

For operation of the slave servo driver 2b independent of the master servo driver 2a, the slave servo driver 2b drives the motor 3b in response to a command from the PLC 1 through the industrial network N1. Through the operation independent of the master servo driver 2a, the slave servo driver 2b can adjust, for example, the relative position of the precision stage 5b to the precision stage 5a. The mode in which the slave servo driver 2b operates independently of the master servo driver 2a, or in other words in which the slave servo driver 2b operates in response to a command received directly from the PLC 1, is hereafter referred to as an independent mode. The independent mode is an example of a second mode.

### Functional Units in PLC 1

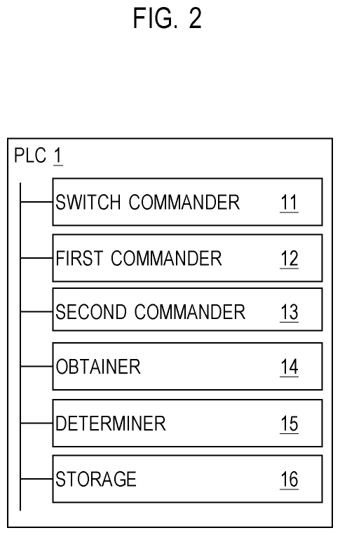

FIG. 2 is a schematic block diagram of the PLC 1, showing its functional units. The PLC 1 may be a computer including, for example, an arithmetic unit and a memory. The functional units shown in FIG. 2 are implemented when the PLC 1 executes, for example, a predetermined program. The PLC 1 includes a switch commander 11, a first commander 12, a second commander 13, an obtainer 14, a determiner 15, a storage 16, and optional other functional units.

The switch commander 11 outputs a switch command for switching between the cooperative mode and the independent mode to the master servo driver 2a and the slave servo driver 2b through the industrial network N1. The switch commander 11 outputs the switch command in response to, for example, an instruction from a user of the servo system 100.

In response to the switch command for switching from the independent mode to the cooperative mode, the master servo driver 2a performs servo control over the motor 3a and outputs the inter-driver command for servo control over the motor 3b to the slave servo driver 2b. In response to the switch command for switching to the cooperative mode, the slave servo driver 2b drives the motor 3b in accordance with the inter-driver command from the master servo driver 2a.

In response to the switch command for switching from the cooperative mode to the independent mode, the master servo driver 2a stops outputting the inter-driver command to the slave servo driver 2b. In response to the switch command for switching to the independent mode, the slave servo driver 2b drives the motor 3b in accordance with the command from the PLC 1. The switch commander 11 may output an error and disable output of a switch command when the determiner 15 determines that the switch command is not to be output.

In response to the switch command for switching to the cooperative mode output from the switch commander 11, the master servo driver 2a and the slave servo driver 2b operate in the cooperative mode. In this mode, the first commander 12 outputs a first command to the master servo driver 2a to drive the motors 3a and 3b. In response to the first command, the master servo driver 2a drives the motor 3a in accordance with the first command and also outputs the inter-driver command to the slave servo driver 2b to cause the motor 3b to operate in accordance with the first command.

In response to the switch command for switching to the independent mode output from the switch commander 11, the master servo driver 2a and the slave servo driver 2b operate in the independent mode. In this mode, the second commander 13 outputs a second command to the slave servo driver 2b to drive the motor 3b. The second commander 13 outputs, to the slave servo driver 2b, the second command including a position command for displacing the output shaft 33b based on, for example, the current position of the output shaft 33b indicated by the information about displacement of the output shaft 33b in the motor 3b obtained by the obtainer 14. In response to the second command, the slave servo driver 2b drives the motor 3b in accordance with the second command. While the motor 3b is being driven in accordance with the second command, the second commander 13 may output a command to the master servo driver 2a to cause the motor 3a to be in a free-running state. The second command is an example of a second control command. The command for causing the motor 3a to be in the free-running state is an example of a third control command.

The obtainer 14 obtains information about the operation of the motors 3 through the industrial network N1. The obtainer 14 obtains information about displacement of the output shaft 33a in the motor 3a from the master servo driver 2a receiving the feedback signal from the motor 3a. The obtainer 14 also obtains information about displacement of the output shaft 33b in the motor 3b from the slave servo driver 2b receiving the feedback signal from the motor 3b. The information about displacement of the output shaft 33a is an example of first displacement information. The information about displacement of the output shaft 33b is an example of second displacement information.

The second command output from the second commander 13 to the slave servo driver 2b may include the position command specifying the position of the motor 3b based on the current position of the output shaft 33b indicated by the information about displacement of the output shaft 33b obtained by the obtainer 14.

The determiner 15 determines whether the switch command is to be output. The determiner 15 may determine whether the switch command is to be output based on, for example, whether the servo drivers 2 are in the servo-on state. The determiner 15 may determine that the switch command for switching from the cooperative mode to the independent mode is to be output when, for example, the master servo driver 2a and the slave servo driver 2b are both in a servo-off state. The determiner 15 may determine that the switch command for switching from the cooperative mode to the independent mode is not to be output when, for example, at least one of the master servo driver 2a or the slave servo driver 2b is in the servo-on state.

The determiner 15 may determine whether the switch command is to be output based on the information about displacement of the output shaft 33a and displacement of the output shaft 33b obtained by the obtainer 14. The determiner 15 may determine that the switch command for switching from the cooperative mode to the independent mode is to be output when, for example, the difference between the position of the precision stage 5a indicated by the information about displacement of the output shaft 33a and the position of the precision stage 5b indicated by the information about displacement of the output shaft 33b is less than a threshold. The determiner 15 may determine that the switch command for switching from the cooperative mode to the independent mode is not to be output when, for example, the difference between the position of the precision stage 5a indicated by the information about displacement of the output shaft 33a and the position of the precision stage 5b indicated by the information about displacement of the output shaft 33b is greater than or equal to a position difference threshold prestored in the storage 16.

The determiner 15 may determine that the switch command for switching from the cooperative mode to the independent mode is to be output when at least one of the servo driver 2a or 2b is in the servo-on state and when the motors 3a and 3b are stopped.

The storage 16 stores, for example, information associated with the process performed by the PLC 1, such as thresholds used by the determiner 15. The storage 16 is, for example, a nonvolatile storage, such as an electrically erasable programmable read-only memory (EEPROM).

### Functional Units in Master Servo Driver 2a

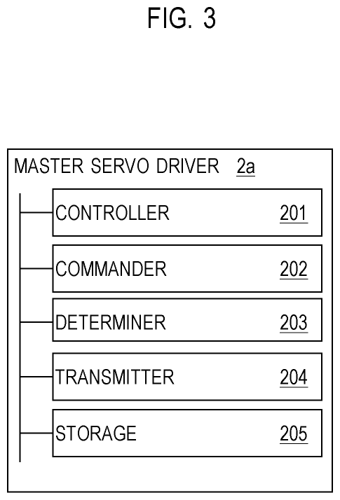

FIG. 3 is a schematic block diagram of the master servo driver 2a, showing its functional units. The master servo driver 2a may be a computer including, for example, an arithmetic unit and a memory. The functional units shown in FIG. 3 are implemented when the master servo driver 2a executes, for example, a predetermined program. The master servo driver 2a includes a controller 201, a commander 202, a determiner 203, a transmitter 204, a storage 205, and optional other functional units.

The controller 201 performs servo control over the motor 3a to drive the motor 3a in accordance with the first command received from the PLC 1 in the cooperative mode. The controller 201 disables driving of the motor 3a in accordance with the first command when the determiner 203 determines that the control is not to be performed. The controller 201 may cause the master servo driver 2a to be in the servo-off state when, for example, the determiner 203 determines that the control is not to be performed.

The commander 202 outputs the inter-driver command to the slave servo driver 2b through the inter-driver communication line N2 to drive the motor 3b in accordance with the first command from the PLC 1. The commander 202 may output the inter-driver command to the slave servo driver 2b through the inter-driver communication line N2 to cause the slave servo driver 2b to be in the servo-off state when the determiner 203 determines that the control is not to be performed. The inter-driver command is an example of a first control command.

The determiner 203 determines whether the motors 3a and 3b can be controlled in accordance with the first command from the PLC 1. For example, the determiner 203 obtains information about displacement of the output shaft 33b from the slave servo driver 2b through the inter-driver communication line N2. The determiner 203 may determine that the motors 3a and 3b can be controlled in accordance with the first command from the PLC 1 when the difference between the position of the precision stage 5a indicated by the feedback signal from the motor 3a and the position of the precision stage 5b indicated by the obtained information about displacement of the output shaft 33b is less than a threshold. The determiner 203 may determine that the motors 3a and 3b cannot be controlled in accordance with the first command from the PLC 1 when the difference between the position of the precision stage 5a indicated by the feedback signal from the motor 3a and the position of the precision stage 5b indicated by the obtained information about displacement of the output shaft 33b is greater than or equal to a position difference threshold prestored in the storage 205.

The transmitter 204 obtains information about displacement of the output shaft 33a based on the feedback signal received from the motor 3a. The transmitter 204 transmits the information about displacement of the output shaft 33a to the PLC 1 through the industrial network N1.

The storage 205 stores, for example, information associated with the process performed by the master servo driver 2a, such as thresholds used by the determiner 203. The storage 205 is, for example, a nonvolatile storage, such as an EEPROM.

### Functional Units in Slave Servo Driver 2b

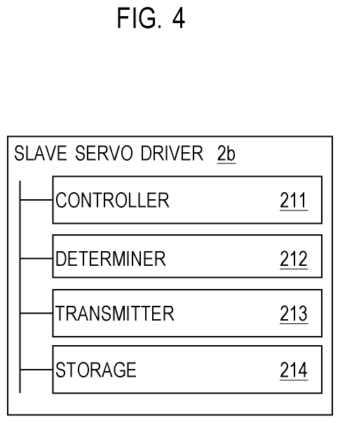

FIG. 4 is a schematic block diagram of the slave servo driver 2b, showing its functional units. The slave servo driver 2b may be a computer including, for example, an arithmetic unit and a memory. The functional units shown in FIG. 4 are implemented when the slave servo driver 2b executes, for example, a predetermined program. The slave servo driver 2b includes a controller 211, a determiner 212, a transmitter 213, a storage 214, and optional other functional units.

The controller 211 performs servo control over the motor 3b. In the cooperative mode, the controller 211 drives the motor 3b in accordance with the inter-driver command received from the master servo driver 2a through the inter-driver communication line N2. In the independent mode, the controller 211 drives the motor 3b in accordance with the second command received from the PLC 1 through the industrial network Ni. In response to a servo-off command from the PLC 1 or from the master servo driver 2a, the controller 211 causes the slave servo driver 2b to be in the servo-off state.

The controller 211 may disable driving of the motor 3b in accordance with the second command when the determiner 212 determines that the control is not to be performed. The controller 211 may cause the slave servo driver 2b to be in the servo-off state when, for example, the determiner 212 determines that the control is not to be performed.

The determiner 212 determines whether the motor 3b can be controlled in accordance with the second command from the PLC 1. The determiner 212 may determine that the motor 3b cannot be controlled in accordance with the second command when, for example, the output shaft 33b has moved in accordance with the second command from the PLC 1, from the position at the reception of the switch command for switching to the independent mode, by an amount greater than or equal to a movement threshold. The movement threshold is an example of a displacement threshold.

The determiner 212 may determine that the control is not to be performed when a command torque value and a command thrust value specified by the second command received from the PLC 1 are greater than or equal to the respective thresholds defined for the command torque value and the command thrust value. The determiner 212 may determine that the control is not to be performed when the position deviation is greater than or equal to a predetermined threshold due to an unexecuted second command stored in, for example, a buffer. The predetermined threshold may be, for example, lower than the threshold for the position deviation used in the independent mode.

The transmitter 213 obtains information about displacement of the output shaft 33b based on the feedback signal received from the motor 3b. The transmitter 213 transmits the information about displacement of the output shaft 33b to the PLC 1 through the industrial network N1. In the cooperative mode, the transmitter 213 transmits the information about displacement of the output shaft 33b also to the master servo driver 2a through the inter-driver communication line N2.

The storage 214 stores, for example, information associated with the process performed by the slave servo driver 2b, such as thresholds used by the determiner 212. The storage 214 is, for example, a nonvolatile storage, such as an EEPROM.

### Process Sequence Performed by PLC 1

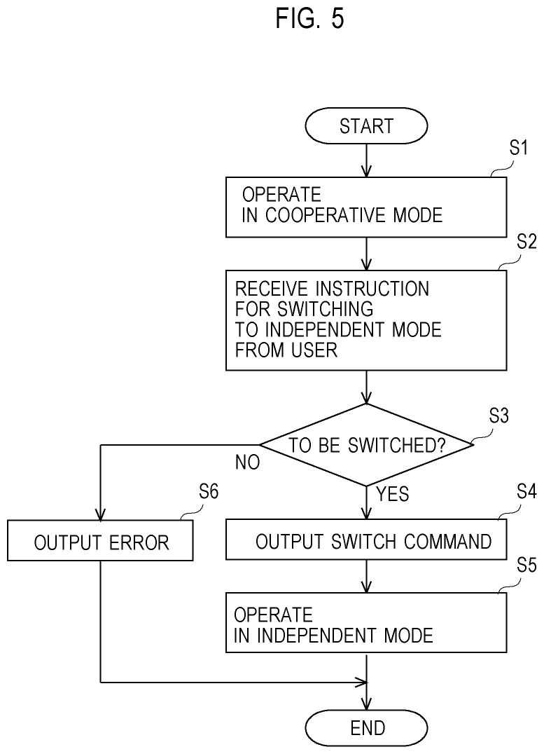

FIG. 5 is a flowchart of an example process sequence performed by the PLC 1. FIG. 5 shows example processing performed when the servo drivers 2 operating in the cooperative mode are switched to the independent mode. An example process sequence performed by the PLC 1 will now be described with reference to FIG. 5.

In S1, the master servo driver 2a and the slave servo driver 2b operate in the cooperative mode. The first commander 12 in the PLC 1 outputs the first command to the master servo driver 2a through the industrial network N1. In response to the first command, the master servo driver 2a drives the motor 3a in accordance with the first command and also outputs the inter-driver command to the slave servo driver 2b to drive the motor 3b in accordance with the first command.

In S2, the PLC 1 receives an instruction for switching to the independent mode from, for example, the user. In S3, the determiner 15 determines whether the switching to the independent mode is to be performed. When the switching is to be performed (Yes in S3), the processing advances to S4. When the switching is not to be performed (No in S3), the processing advances to S6.

In S4, the switch commander 11 outputs the switch command for switching from the cooperative mode to the independent mode to the master servo driver 2a and the slave servo driver 2b through the industrial network N1. In S5, the servo drivers 2 operate in the independent mode. The PLC 1 outputs the second command to the slave servo driver 2b through the industrial network N1 to drive the motor 3b.

In S6, the switch commander 11 outputs an error and disables output of a switch command for switching from the cooperative mode to the independent mode. The error may be output using, for example, a warning sound, a message on a display, or transmission of an email.

### Process Sequence Performed by Master Servo Driver 2a

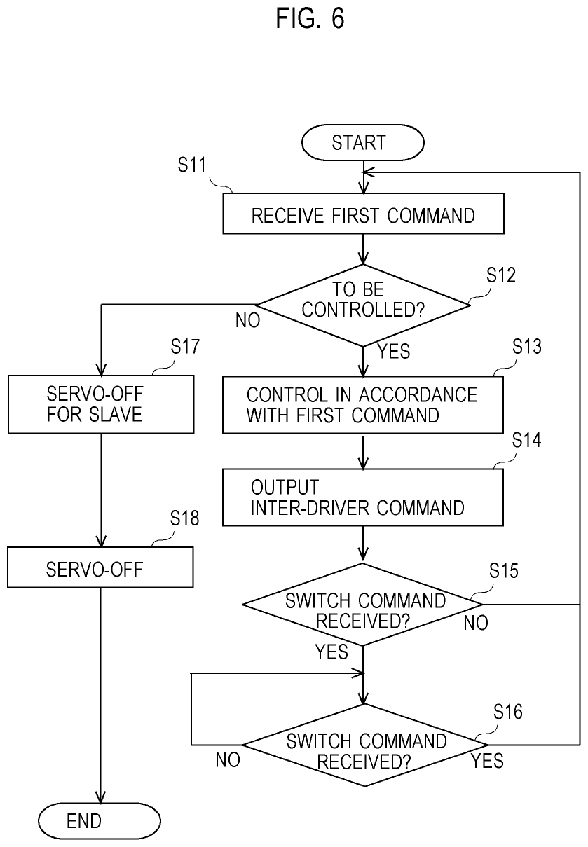

FIG. 6 is a flowchart of an example process sequence performed by the master servo driver 2a. FIG. 6 shows example processing performed when the master servo driver 2a operating in the cooperative mode receives, from the PLC 1, the switch command for switching to the independent mode. An example process sequence performed by the master servo driver 2a will now be described with reference to FIG. 6.

In S11 to S14 and S17 to S18, the master servo driver 2a operates in the cooperative mode. In S11, the master servo driver 2a receives the first command from the PLC 1. The determiner 203 determines whether the control in accordance with the first command received in S11 is to be performed. When the control is to be performed (Yes in S12), the processing advances to S13. When the control is not to be performed (No in S12), the processing advances to S18.

In S13, the controller 201 controls the motor 3a in accordance with the first command received in S11. The transmitter 204 transmits, to the PLC 1 through the industrial network N1, information about displacement of the output shaft 33a obtained based on the feedback signal received from the motor 3a.

In S14, the commander 202 outputs the inter-driver command to the slave servo driver 2b to control the motor 3b in accordance with the first command received at the switch commander 11.

When the switch command for switching from the cooperative mode to the independent mode has been received from the PLC 1 (Yes in S15), the processing advances to S16. When the switch command has not been received (No in S15), the processing advances to S11.

In S16, the master servo driver 2a operates in the independent mode without outputting the inter-driver command to the slave servo driver 2b. In S16, the master servo driver 2a determines whether the switch command for switching from the independent mode to the cooperative mode has been received. When the switch command has been received (Yes in S16), the processing advances to S11. When the switch command has not been received (No in S16), the processing in S16 is repeated. In other words, the master servo driver 2a waits until receiving the switch command for switching from the independent mode to the cooperative mode.

In S17, the commander 202 outputs the inter-driver command to the slave servo driver 2b to cause the slave servo driver 2b to be in the servo-off state. In S18, the controller 201 causes the master servo driver 2a to be in the servo-off state.

### Process Sequence Performed by Slave Servo Driver 2b

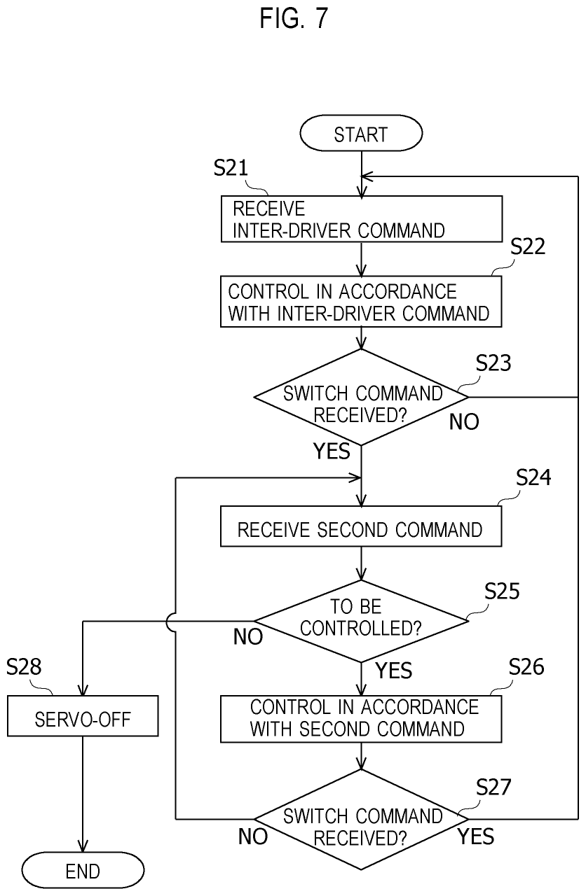

FIG. 7 is a flowchart of an example process sequence performed by the slave servo driver 2b. FIG. 7 shows example processing performed when the slave servo driver 2b operating in the cooperative mode receives, from the PLC 1, the switch command for switching to the independent mode. An example process sequence performed by the slave servo driver 2b will now be described with reference to FIG. 7.

In S21 to S22, the slave servo driver 2b operates in the cooperative mode. In S21, the controller 211 receives the inter-driver command from the master servo driver 2a. In S22, the controller 211 controls the motor 3b in accordance with the inter-driver command received in S21. The transmitter 213 transmits, to the PLC 1 through the industrial network N1, information about displacement of the output shaft 33b obtained based on the feedback signal received from the motor 3b. The transmitter 213 also transmits, to the master servo driver 2a through the inter-driver communication line N2, the information about displacement of the output shaft 33b obtained based on the feedback signal received from the motor 3b.

When the switch command for switching from the cooperative mode to the independent mode has been received from the PLC 1 (Yes in S23), the processing advances to S24. When the switch command has not been received (No in S23), the processing advances to S21.

In S24, the controller 211 receives the second command from the PLC 1. In S25, the determiner 212 determines whether the motor 3b can be controlled in accordance with the second command received in S24. When the control is to be performed (Yes in S25), the processing advances to S26. When the control is not to be performed (No in S25), the processing advances to S28. In S26, the controller 211 drives the motor 3b in accordance with the second command received in S24. The transmitter 213 transmits, to the PLC 1 through the industrial network N1, information about displacement of the output shaft 33b obtained based on the feedback signal received from the motor 3b.

In S27, the slave servo driver 2b determines whether the switch command for switching from the independent mode to the cooperative mode has been received. When the switch command has been received (Yes in S27), the processing advances to S21. When the switch command has not been received (No in S27), the processing advances to S24. In S28, the controller 211 causes the slave servo driver 2b to be in the servo-off state.

### Effects of Embodiment

In the present embodiment, the slave servo driver 2b is connected to the master servo driver 2a with the inter-driver communication line N2 and to the PLC 1 with the industrial network N1. The PLC 1 can output the second command to the slave servo driver 2b directly (without using the master servo driver 2a) through the industrial network N1. The command from the PLC 1, which is output to the slave servo driver 2b without being through the master servo driver 2a, reaches the slave servo driver 2b with less delay.

In the servo system 100 according to the present embodiment, the master servo driver 2a and the slave servo driver 2b are operable in cooperation with each other, and the slave servo driver 2b is drivable also independently with highest possible control accuracy. For example, the system according to the present embodiment can use the second command output from the PLC 1 to the slave servo driver 2b to correct a relative misalignment between the output shaft 33a and the output shaft 33b occurring in the cooperative operation.

In the present embodiment, the PLC 1 can directly obtain information about displacement of the output shaft 33b from the slave servo driver 2b through the industrial network N1. The information about displacement of the output shaft 33b can thus be obtained with less delay than when being obtained through the master servo driver 2a. In the servo system 100 with this structure, the master servo driver 2a and the slave servo driver 2b are operable in cooperation with each other, and the slave servo driver 2b is drivable also independently with highest possible control accuracy.

In the present embodiment, the PLC 1 outputs, to the slave servo driver 2b, the position command for displacing the output shaft 33b based on the current position of the output shaft 33b indicated by the information about displacement of the output shaft 33b in the motor 3b obtained by the obtainer 14. In the present embodiment, the position command for the slave servo driver 2b is based on the current position obtained from the slave servo driver 2b, thus increasing the accuracy of the position command.

In the present embodiment, the switch command for switching from the cooperative mode to the independent mode is not to be output when the difference between the position of the precision stage 5a indicated by the information about displacement of the output shaft 33a and the position of the precision stage 5b indicated by the information about displacement of the output shaft 33b is greater than or equal to the position difference threshold. In the present embodiment, the table 6 shows relative movement between the precision stage 5a and the precision stage 5b. In this structure, the motors 3a and 3b can receive an overload with a large difference between the positions of the precision stage 5a and the precision stage 5b. In the present embodiment, the motors 3a and 3b avoid an overload by regulating the difference between the positions of the precision stage 5a and the precision stage 5b using the threshold.

In the present embodiment, the switch command for switching from the cooperative mode to the independent mode is not output when at least one of the master servo driver 2a or the slave servo driver 2b is in the servo-on state. When at least one of the master servo driver 2a or the slave servo driver 2b is in the servo-on state, the servo system 100 can receive an overload in response to the motor 3b being driven independently of the motor 3a. In the above state, the servo system 100 according to the present embodiment disables output of a switch command for switching from the cooperative mode to the independent mode, thus avoiding an overload.

In the present embodiment, the switch command for switching from the cooperative mode to the independent mode is to be output when at least one of the master servo driver 2a or the slave servo driver 2b is in the servo-on state and when the motor 3a and the motor 3b are stopped. When at least one of the master servo driver 2a or the slave servo driver 2b is in the servo-on state but the motor 3a and the motor 3b are both stopped, the servo system 100 is less likely to receive an overload in response to the motor 3b being driven independently of the motor 3a. Thus, the servo system 100 according to the present embodiment can output a switch command for switching from the cooperative mode to the independent mode while avoiding an overload.

In the present embodiment, the slave servo driver 2b disables driving of the motor 3b in accordance with the second command when the output shaft 33b has moved in accordance with the second command from the PLC 1, from the position at the reception of the switch command for switching to the independent mode, by an amount greater than or equal to the movement threshold. The servo system 100 can receive an overload when largely displacing the motor 3b independently of the motor 3a. In the present embodiment, the servo system 100 regulates displacement of the motor 3b in the independent mode using the threshold, thus avoiding an overload.

In the present embodiment, the slave servo driver 2b disables driving of the motor 3b in accordance with the second command when the command torque value and the command thrust value specified by the second command received from the PLC 1 are greater than or equal to the respective thresholds defined for the command torque value and the command thrust value. The servo system 100 can receive an overload when driving the motor 3b with high torque independently of the motor 3a. In the present embodiment, the servo system 100 regulates the command torque value and the command thrust value specified by the second command in the independent mode using the thresholds, thus avoiding an overload.

In the present embodiment, the PLC 1 outputs the command to the master servo driver 2a to cause the motor 3a to be in the free-running state while the motor 3b is being driven in accordance with the second command. The motor 3a in the free-running state can be easily displaced as the motor 3b is driven and displaced in accordance with the second command. Modifications

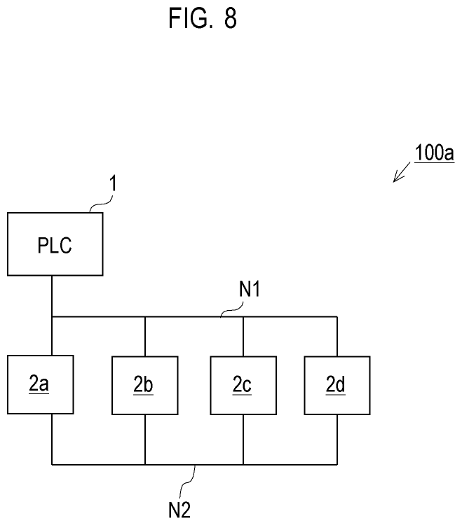

The servo system 100 according to the above embodiment is a two-axis servo system including the master servo driver 2a and the slave servo driver 2b. In some embodiments, the servo system 100 may have three or more axes. FIG. 8 is a block diagram of an example servo system 100a according to a modification. FIG. 8 does not show components other than a PLC 1, servo drivers 2, an industrial network N1, and an inter-driver communication line N2. In the example of FIG. 8, the servo system 100a includes four servo drivers 2a, 2b, 2c, and 2d. The servo system 100a is connected to the servo drivers 2a, 2b, 2c, and 2d with the industrial network N1. The servo drivers 2a, 2b, 2c, and 2d are connected with the inter-driver communication line N2. In the cooperative mode, the master servo driver 2a may output a command to the servo drivers 2b, 2c, and 2c through the inter-driver communication line N2. In the cooperative mode, the master servo driver 2a may output a command to the slave servo driver 2b through the inter-driver communication line N2, and the servo driver 2c may output a command to the servo driver 2d through the inter-driver communication line N2. In other words, a master servo driver may be selected from the multiple servo drivers included in the servo system 100a.

### Appendix

A servo system (100), comprising:
a first servo driver (2a) configured to drive a first motor (3a);
a second servo driver (2b) connected to the first servo driver (2a) with a first signal line (N2), the second servo driver (2b) being configured to drive a second motor (3b) in accordance with a control command from the first servo driver (2a); and
a host device (1) connected to the first servo driver (2a) and the second servo driver (2b) with a second signal line (N1),
wherein the second servo driver (2b) switches between a first mode and a second mode in response to a switch command from the host device (1), the first mode is a mode in which the second servo driver (2b) drives the second motor (3b) in accordance with a first control command from the first servo driver (2a), and the second mode is a mode in which the second servo driver (2b) drives the second motor (3b) in accordance with a second control command from the host device (1).

1. A servo system, comprising:
a first servo driver configured to drive a first motor;
a second servo driver connected to the first servo driver with a first signal line, the second servo driver being configured to drive a second motor; and
a host device connected to the first servo driver and the second servo driver with a second signal line,
wherein the second servo driver switches between a first mode and a second mode in response to a switch command from the host device, the first mode is a mode in which the second servo driver drives the second motor in accordance with a first control command from the first servo driver, and the second mode is a mode in which the second servo driver drives the second motor in accordance with a second control command from the host device.

2. The servo system according to claim 1, wherein
the host device obtains, from the second servo driver, second displacement information about displacement of the second motor, and outputs the second control command to the second servo driver based on a current position of the second motor indicated by the second displacement information.

3. The servo system according to claim 1, wherein
the host device obtains, from the first servo driver, first displacement information about displacement of the first motor, obtains, from the second servo driver, second displacement information about displacement of the second motor, and disables output of the switch command for switching from the first mode to the second mode in response to a difference between the displacement of the first motor indicated by the first displacement information and the displacement of the second motor indicated by the second displacement information being greater than or equal to a position difference threshold prestored in a storage.

4. The servo system according to claim 1, wherein
the host device disables output of the switch command for switching from the first mode to the second mode in response to at least one of the first servo driver or the second servo driver being in a servo-on state.

5. The servo system according to claim 1, wherein
the host device enables output of the switch command for switching from the first mode to the second mode in response to at least one of the first servo driver or the second servo driver being in a servo-on state and the first motor and the second motor being stopped.

6. The servo system according to claim 1, wherein
the second servo driver disables driving of the second motor in accordance with the second control command from the host device in response to a difference between displacement of the second motor at reception of the switch command for switching from the first mode to the second mode and displacement of the second motor in accordance with the second control command from the host device being greater than or equal to a displacement threshold prestored in a storage.

7. The servo system according to claim 1, wherein
the second servo driver disables control of the second motor in accordance with the second control command from the host device in response to a command torque value specified by the second control command from the host device being greater than or equal to a torque threshold prestored in a storage.

8. The servo system according to claim 1, wherein
the host device outputs the second control command to the second servo driver to drive the second motor, and outputs a third control command to the first servo driver to cause the first motor to be in a free-running state.
